(19) United States
(12) Patent Application Publication
(10) Pub. No.: US 2019/0325765 A1
(43) Pub. Date: Oct. 24, 2019

(54) SYSTEM FOR EVALUATING CONTENT DELIVERY AND RELATED METHODS

(71) Applicant: Sarah Wakefield, Kingwood, TX (US)

(72) Inventor: Sarah Wakefield, Kingwood, TX (US)

(21) Appl. No.: 16/387,317

(22) Filed: Apr. 17, 2019

Related U.S. Application Data
(60) Provisional application No. 62/661,076, filed on Apr. 22, 2018.

(51) Int. Cl. G09B 5/02; G09B 5/04

(52) U.S. Cl. CPC G09B 5/02; G09B 5/04

(57) ABSTRACT

Systems, methods, and computer program products for facilitating the objective evaluation of at least one segment of content delivery are disclosed. In an aspect, the systems, methods, and computer program products of the present disclosure may be configured to receive one or more segments of content delivery and/or third-party data associated with the segment(s) and determine at least one quality indicator for the segment(s). The at least one quality indicator may comprise various types of information or data that may be used by one or more computing devices to determine at least one quality aspect of the segment(s) of content delivery, including but not limited to whether a desirable variety of active and passive learning techniques are used, whether differentiation of instruction is achieved, whether spaced learning occurs, whether learners seem to be properly motivated, whether learners are likely to retain presented information, and the like.

### FIELD OF THE DISCLOSURE

The present disclosure generally relates to the assessment of content delivery and more particularly to systems, methods, and computer program products for facilitating the evaluation of at least one amount of at least one type of delivered content.

### BACKGROUND

The statements in this section merely provide background information related to the present disclosure and may not constitute prior art.

Effective communication of content, whether it be verbal, written, or via other audio and/or visual means, is important in many human endeavors. Teachers must effectively communicate content to students in order for effective learning to take place, supervisors must communicate content effectively to employees in order to obtain desired outcomes, talk show hosts and politicians must deliver content clearly in order to be understood and gain popularity, and so on. While it is relatively straightforward to evaluate the effectiveness of content delivery after the content has been delivered, it would be helpful to assess the quality of content delivery before it has been delivered and/or while delivery is taking place.

With regard to education, in many cases, a certain amount of education must be received in order to obtain various degrees, licenses, or other qualifications. While educational requirements are common in many schools, fields, and industries, the quality and effectiveness of the delivered education is oftentimes unaccounted for. That is, while there are many ways to make sure individuals receive a required amount of education (e.g., track attendance, monitor participation, review received course content, etc.) and/or to ensure individuals possess a certain amount of knowledge (e.g., get certain test scores, complete various assignments, etc.), there are not efficient ways to evaluate the quality of the instruction itself. This may lead to instances, for example, in which individuals attend training courses and do not learn or retain important information and/or to situations in which individuals perform well on tests by using existing knowledge instead of learned knowledge, thereby giving a false sense of course effectiveness. Without an efficient objective means for evaluating the quality of the educational instruction or content itself, the purchasers of the content (such as students, corporations, parents, etc.) do not have a reliable measurement of whether they are getting their money's worth and the designers of educational instruction courses lack information on how to best structure course content.

Currently, companies exist that will send one or more individuals to “audit” various training courses or other types of educational content. While these individuals and companies are useful in getting an inside look at what goes on during course sessions, the audits they perform often tend to be biased based on the observers' beliefs, opinions, and ability to perceive and record various types of information. They also take longer than is necessary (sometimes as long as two weeks or more).

Given the foregoing, what is needed are systems, methods, and computer program products which facilitate the ability of an individual or entity to objectively measure the quality of at least one portion or segment of delivered content.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the present disclosure meet the above-identified needs by providing systems, methods, and computer program products which facilitate the ability of an individual or entity to measure the quality of delivered content. Specifically, in an aspect, systems, methods, and computer program products are disclosed wherein at least one content delivery quality indicator is noted or evaluated one or more times within at least one segment of content delivery in order to determine a measurable quantitative quality or effectiveness of the content segment. The at least one content delivery quality indicator may be recorded manually by at least one human user, such as the content or one or more observers of the content delivery; or, the at least one content delivery quality indicator may be observed and/or recorded by one or more computing devices in an at least partially autonomous fashion.

In some aspects, the systems, methods, and computer program products of the present disclosure may be well suited for evaluating the delivery of educational content, including internet-based or “online” educational content (often referred to as “eLearning” or “web-based-training”). In such aspects, one or more computing devices may include computational instructions, or code, in the form of software or one or more software applications that, when executed on at least one computer processor, cause the at least one computer processor to perform certain steps or processes, including receiving at least one segment of deliverable educational content and/or data associated therewith, determining at least one quality indicator for the at least one segment of deliverable educational content, and presenting the at least one quality indicator to at least one user. In some additional aspects, the at least one user may use one or more input devices to manually input one or more quality indicators and/or to adjust which quality indicator(s) are tracked, monitored, noted, recorded, and/or analyzed.

In some aspects, the one or more computing devices that may be associated with the systems, methods, and computer program products of the present disclosure may include software or one or more software applications that are configured to retrieve, view, and interpret one or more types of third-party data (e.g., SCORM® (Sharable Content Object Reference Model), xAPI (also known as Experience API and/or “Tin Can”), cmi5, Caliper Analytics®, or AICC (Aviation Industry Computer-Based Training Committee) data) that may be associated with one or more deliverable educational content segments that are software or internet based. The interpreted third-party data may then be used to analyze the at least one segment of deliverable educational content in order to determine at least one quality indicator for the at least one segment of deliverable educational content and then, optionally, present the at least one quality indicator to at least one user. The third-party data may come from a user-designed course, a learning management system (LMS), a learning record store (LRS), a content management system (CMS), a component content management system (CCMS), a training analytics or evaluation database, a training evaluation system, or similar source.

In some aspects, the quality indicator(s) that may be determined by the systems, methods, and computer program products of the present disclosure may enable one or more users to form an accurate assessment of the quality of one or more educational instruction courses and/or programs in order to determine whether they are cost effective. Additionally, the quality indicator(s) may help course designers structure their course content more effectively by helping the designers identify an optimal course structure and/or framework.

Various types of quality indicators may be identified via the systems, methods, and computer program products of the present disclosure. For example, quality indicators may comprise a determination of instances wherein passive or active learning techniques are utilized. It has been shown that an effective balance of active and passive teaching styles may help students or learners absorb and retain presented material. Passive learning instances may comprise watching a video, listening to a lecture, or any similar learning experience in which the learner has a relatively low level of physical and/or social engagement (e.g., the learner just has to “listen”) with an educational content segment; on the other hand, active learning instances may include situations wherein the learner has to “do” something, which may comprise participating in a group discussion, asking or answering questions, completing a hands-on activity, or any similar learning experience wherein the learner has a relatively high level of physical and/or social engagement with an educational content segment. Monitoring this balance between active and passive learning is not currently accounted for in common course audit programs. Similar quality indicators may be identified and monitored for various other types of deliverable content as well, including talk show broadcasts, political speeches, live performances (e.g., actors and comedians), supervisor instructions to employees, interactions between patients and healthcare providers, and the like.

In some aspects, the computing device(s) associated with the systems, methods, and computer program products of the present disclosure may further include software or one or more software applications that are configured to determine at least one aspect of the quality of at least one segment of deliverable educational content based on the quality indicator(s) determined for such segment(s).

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of an exemplary system for facilitating the identification of and/or determination of at least one quality indicator and/or aspect of quality for at least one segment of content delivery, according to an aspect of the present disclosure.

FIG. 2 is a flowchart illustrating an exemplary process for evaluating the quality of at least one segment of content delivery, according to an aspect of the present disclosure.

FIG. 3 is a flowchart illustrating an exemplary process for determining at least one quality indicator for and evaluating the quality of at least one segment of content delivery, according to an aspect of the present disclosure.

FIG. 4 is a flowchart illustrating an exemplary process for determining at least one quality indicator for and evaluating the quality of at least one segment of content delivery based at least partially on at least one type of third-party data, according to an aspect of the present disclosure.

FIG. 5 is a block diagram of an exemplary computing system useful for implementing one or more aspects of the present disclosure.

### DETAILED DESCRIPTION

The present disclosure is directed to systems, methods, and computer program products that facilitate the ability of at least one user to assess the quality and/or effectiveness of at least one segment of content delivery. Specifically, in an aspect, systems, methods, and computer program products are disclosed that use computational instructions, or code, in the form of software and/or one or more software applications that, when executed by one or more computer processors, causes the processor(s) to perform certain steps in order to receive at least one segment of content delivery and/or third-party data that may be associated therewith, determine at least one quality indicator for the at least one segment of content delivery, and present the at least one quality indicator to at least one user. In some aspects, the software and/or one or more software applications may further use the at least one quality indicator to determine at least one aspect of the quality of at least one segment of content delivery and present the at least one aspect of quality to the at least one user. In some additional aspects, the at least one user may manually input the at least one quality indicator. In still some additional aspects, the software and/or one or more software applications may use at least one type of third-party data (such as, by way of example and not limitation, SCORM®, xAPI, cmi5, Caliper Analytics®, or AICC data associated with online educational content) in order to determine the at least one quality indicator.

Various types of quality indicators may be identified via the systems, methods, and computer program products of the present disclosure. For example, quality indicators for educational content may comprise a determination of instances when passive or active learning techniques were utilized. It has been shown that an effective balance of active and passive teaching styles may help students or learners absorb and retain learned material. Passive learning instances may comprise watching a video, listening to a lecture, or any similar learning experience in which the learner has a relatively low level of physical and/or social engagement (e.g., the learner just has to “listen”) with the educational content segment; on the other hand, active learning instances may include situations wherein the learner has to “do” something, which may comprise participating in a group discussion, asking or answering questions, completing a hands-on activity, or any similar learning experience wherein the learner has a relatively high level of physical and/or social engagement with the educational content segment.

The term “content delivery” and/or the plural form of this term are used throughout herein to refer to any type of content (e.g., verbal, written, pictorial, graphical, audiovisual, physical, electronic, etc.) that may be presentable, is bring presented, and/or has been presented, either in person, tangibly, virtually (e.g., remotely), and/or electronically (e.g., via software and/or online), to at least one content recipient, such as teaching sessions; talk show broadcasts; political speeches; acting performances; comedian performances; written and verbal supervisor instructions to employees; written and verbal interactions between patients and healthcare providers; coded text, dialogue, and/or images used in academic research studies; written and verbal interactions between coworkers; written and verbal interactions between business workers and customers; employee performance evaluations; restaurant health inspections; restaurant sanitation guidelines; and the like. A “segment” of content delivery or may refer to any portion of a certain type of content delivery, such as a certain amount of time during a lecture, an email from a supervisor to an employee, a clip from a comedy show, a portion of a talk show broadcast, and the like. In some instances in the present disclosure, the term “deliverable content” may be used interchangeably with the term “content delivery.”

The term “educational content” and/or the plural form of this term are used throughout herein to refer to any material, instruction, content, or information that may be presentable, either in person, virtually (e.g., remotely), and/or electronically (e.g., via software and/or online), to at least one learner wherein the at least one learner is intended to learn from the presented material/instruction/content/information, such as teaching sessions (either in person, virtual (e.g., remotely, such as online, substantially in real time), or electronic (e.g., prerecorded and viewed later, such as online)), software-based or online-based courses (such as “eLearning” courses) (e.g., either live or self-paced), and the like. A “segment” of educational content may refer to any portion of a certain type of educational content, such as a certain amount of time during a lecture, an amount of eLearning content, one or more parts of a series, and the like.

The term “quality indicator” and/or the plural form of this term are used throughout herein to refer to any instance, occurrence, technique, tool, method, or approach utilized during at least one segment of content delivery that may be indicative of the overall quality of the segment(s) of content delivery, such as when or whether an active or passive learning instance occurs (e.g., a discussion may comprise active learning while a lecture may comprise passive learning); what type of active or passive learning instance occurs (e.g., a discussion, laboratory experiment, lecture, group activity, question and answer session, etc.); whether the content delivery segment allows learner(s) to branch into different activities or topics (and if so, how many times this occurs); whether an informal question is asked by the content deliverer; whether a reference to a real-life application is made by the content deliverer or other feature of the at least one segment of content delivery; whether the content deliverer or other feature of the at least one segment of content delivery indicates how learner(s) may benefit from a piece of information; whether previously presented information is reviewed; whether one or more training props, visual aids and/or models are used (and whether their design and subject matter are appropriate); whether an effective classroom environment is maintained (e.g., whether the environment is relaxed and comfortable); whether the content deliverer practices good presentation skills (e.g. maintains natural eye contact, avoids “non-words” (e.g., “umm,” “er,” “uhh,” etc.)); whether the content deliverer uses appropriate vocal inflections (e.g., whether the deliverer shows enthusiasm); whether the content deliverer uses good/appropriate diction; whether the content deliverer references course framework; how long it takes learner(s) to perform an action or answer a question once asked to do so (such as, for example and not limitation, how long it takes learner(s) to get out calculators when prompted) (e.g., to measure learner motivation), and the like.

The term “user” and/or the plural form of this term are used throughout herein to refer to any individual or entity, whether real or artificial, that may be responsible for and/or otherwise concerned with the quality of one or more segments of content delivery such as, teachers, politicians, employers, employees, salespeople, managers, supervisors, healthcare providers, patients, announcers, broadcasters, public speakers, colleges, learners/students, parents, corporation leaders, school administrators, governmental entities, investigators (e.g., legal, insurance, accident, etc.), legal professionals, educational content observers or auditors, actors, comedians, radio networks, television networks, and the like.

The term “content recipient” and/or the plural form of this term are used throughout herein to refer to any individual or entity that may be the intentional or unintentional receiver of at least one segment of content delivery, such as students, learners, listeners, audience members, voters, members of the general public, and the like.

The term “learner” and/or the plural form of this term are used throughout herein to refer to one or more individuals or entities intended to receive at least one segment of educational content, such as students, employees, working professionals, and the like.

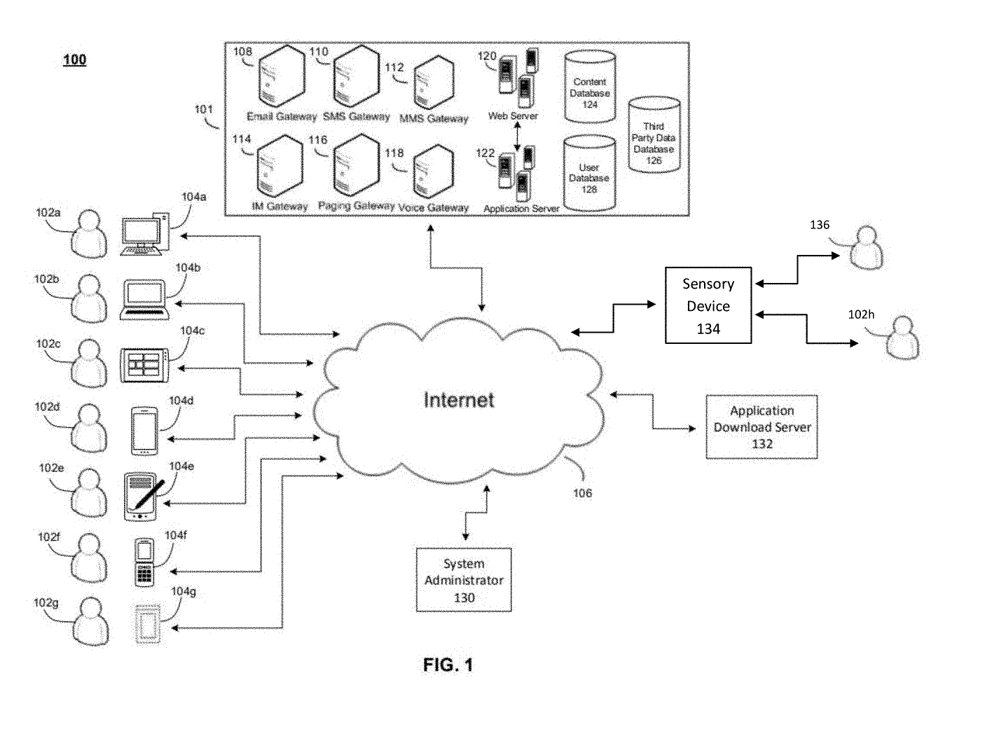

Referring now to FIG. 1, a block diagram of an exemplary system 100 for facilitating the identification of and/or determination of at least one quality indicator and/or aspect of quality for at least one segment of content delivery, according to an aspect of the present disclosure, is shown.

Cloud-based, Internet-enabled device communication system 100 may include a plurality of users 102 (shown as users 102a-g in FIG. 1) accessing, via a computing device 104 (shown as respective computing devices 104a-g in FIG. 1) and a network 106, such as the global, public Internet—an application service provider's cloud-based, Internet-enabled infrastructure 101. In some aspects, a user application may be downloaded onto computing device 104 from an application download server 132. Application download server 132 may be a public application store service or a private download service or link. Computing device 104 may access application download server 132 via network 106. In another nonlimiting embodiment, infrastructure 101 may be accessed via a website or web application. Multiple users 102 may, simultaneously or at different times, access (via, for example, a user application) infrastructure 101 in order to engage in communication with other users 102 and/or to access content database 124, third-party data database 126, and/or user database 128. In some additional aspects, system 100 may further comprise at least one sensory device 134 configured to observe one or more users 102 (shown as user 102h in FIG.1) and/or one or more content recipients 136 and communicate those observations to one or more computing devices 104. By way of example and not limitation, sensory device 134 may comprise a camera and/or microphone, as well as a wearable technology device such as a heart rate monitor, sphygmomanometer, and/or pulse oximeter, as well as any similar device(s) configured to capture behavioral, speech, and/or biological data for one or more users 102 and/or content recipients 136. It is noted that in some aspects, one or more content recipients 136 may receive content without using any sensory device(s) 134. In some additional aspects, one or more content recipients 136 may receive content via one or more computing devices 104.

In various aspects, computing device 104 may be configured as: a desktop computer 104a, a laptop computer 104b, a tablet or mobile computer 104c, a smartphone or wearable smart device (alternatively referred to as a mobile device) 104d, a Personal Digital Assistant (PDA) 104e, a mobile phone 104f, a handheld scanner 104g, any commercially-available intelligent communications device, or the like.

As shown in FIG. 1, in an aspect of the present disclosure, an application service provider's cloud-based, communications infrastructure 101 may include an email gateway 108, an SMS (Short Message Service) gateway 110, an MMS (Multimedia Messaging Service) gateway 112, an Instant Message (IM) gateway 114, a paging gateway 116, a voice gateway 118, one or more web servers 120, one or more application servers 122, a content database 124, a third-party data database 126, and a user database 128. Application server(s) 122 may contain computational instructions, or code, that enables the functionality of system 100. Content database 124, third-party data database 126, and/or user database 128 may not necessarily be contained within infrastructure 101, such as, but not limited to, content database 124, third-party data database 126, and/or user database 128 may be supplied by a third party. As will be appreciated by those skilled in the relevant art(s) after reading the description herein, communications infrastructure 101 may include one or more additional storage, communications, and/or processing components to facilitate communication within system 100, process data, store content, and the like.

Content database 124 may be configured to store content pertaining to one or more content delivery segments. By way of example and not limitation, content delivery segment(s) may comprise at least one portion of various teaching sessions (either in person, virtual (e.g., remotely, such as online, in substantially real time), or electronic (e.g., prerecorded and viewed later, such as online)), online courses (such as “eLearning” courses) (e.g., either live or self-paced), one or more segments of a talk show, written communication from a supervisor to an employee, one or more clips from a comedy show, a healthcare provider's consultation with a patient, and the like. Content information that may be stored within content database 124 may include, by way of example and not limitation, a segment of deliverable content's type (e.g., whether it is a portion of an in-person teaching session, part of an online course, a segment from a talk show, etc.), content provider identification(s), content delivery segment duration (e.g., time of presentation, course length, email length, performance time, etc.), payment information for a segment of content delivery (e.g., price, acceptable and/or preferred method of payment, etc.), and the like.

Third-party data database 126 may be configured to store information pertaining to at least one source of third-party data (e.g., SCORM® data, xAPI data, cmi5 data, Caliper Analytics® data, AICC data, etc.) that may be received, interpreted, and/or utilized by system 100 in order to determine at least one quality indicator for at least one segment of content delivery, such as educational content, and/or to determine at least one aspect of the quality of at least one segment of content delivery. Third-party data information that may be stored within third-party data database 126 may include, by way of example and not limitation, an identification of the third party providing the data (if relevant), data type (e.g., SCORM® data, xAPI data, cmi5 data, Caliper Analytics® data, AICC data, etc.), instructions (or code) for using the data to interpret (or pull) relevant information from at least one segment of content delivery, and the like.

User database 128 may be configured to store information pertaining to one or more users 102. In an aspect, user 102 may comprise any individual or entity that may be responsible for and/or otherwise concerned with the quality of one or more segments of content delivery (e.g., colleges, learners/students, parents, corporation leaders, educational content observers or auditors, radio networks, television networks, etc.). User 102 information that may be stored within user database 128 may include, by way of example and not limitation, a particular user's 102 name, type (e.g., whether user 102 is an individual, business entity, nonprofit organization, etc.), account or profile information (e.g., account settings, account usage history, background information regarding user 102, etc.), location, infrastructure 101 usage history, login credentials (including, but not limited to, passwords, usernames, passcodes, pin numbers, fingerprint scan data, retinal scan data, voice authentication data, facial recognition information, etc.), and the like.

Content database 124, third-party data database 126, and user database 128 may be physically separate from one another, logically separate, or physically or logically indistinguishable from some or all other databases.

A system administrator 130 may access infrastructure 101 via the Internet 106 in order to oversee and manage infrastructure 101.

As will be appreciated by those skilled in the relevant art(s) after reading the description herein, an application service provider—and individual person, business, or other entity—may allow access, on a free registration, paid subscriber, and/or pay-per-use basis, to infrastructure 101 via one or more World-Wide Web (WWW) sites on the Internet 106. Thus, system 100 is scalable.

As will also be appreciated by those skilled in the relevant art(s), in an aspect, various screens may be generated by server 120 in response to input from user(s) 102 over Internet 106. As a nonlimiting example, server 120 may comprise a typical web server running a server application at a website which sends out webpages in response to Hypertext Transfer Protocol (HTTP) or Hypertext Transfer Protocol Secured (HTTPS) requests from remote browsers on various computing devices 104 being used by various users 102. Thus, server 120 is able to provide a graphical user interface (GUI) to users 120 that utilize system 100 in the form of webpages. These webpages are sent to the user's 102 PC, laptop, mobile device, PDA, or like device 104, and would result in the GUI being displayed.

As will be appreciated by those skilled in the relevant art(s) after reading the description herein, alternate aspects of the present disclosure may include providing a tool for facilitating the evaluation of the quality of at least one segment of content delivery to user(s) 102 via computing device(s) 104 as a stand-alone system (e.g., installed on one server PC) or as an enterprise system wherein all the components of system 100 are connected and communicate via an inter-corporate Wide Area Network (WAN) or Local Area Network (LAN). For example, in an aspect where users 102 are all personnel/employees of the same company or are all members of the same group, the present disclosure may be implemented as a stand-alone system, rather than as a web service (i.e., Application Service Provider (ASP) model utilized by various unassociated/unaffiliated users) as shown in FIG. 1.

As will also be appreciated by those skilled in the relevant art(s) after reading the description herein, alternate aspects of the present disclosure may include providing the tools for facilitating the evaluation of the quality of at least one segment of content delivery to user(s) 102 via infrastructure 101 and/or computing device(s) 104 via a browser or operating system pre-installed with an application or a browser or operating system with a separately downloaded application on such computing device(s) 104. That is, as will also be apparent to those skilled in the relevant art(s) after reading the description herein, the application that facilitates the evaluation of at least one segment of content delivery may be part of the “standard” browser or operating system that ships with computing device 104 or may be later added to an existing browser or operating system as part of an “add-on,” “plug-in,” or “app store download.”

Infrastructure 101 may be encrypted to provide for secure communications. A security layer may be included that is configurable using a non-hard-cooled technique selectable by user 102 which may be based on at least one of: user 102, country encryption standards, etc. A type of encryption may include, but is not limited to, protection at least at one communication protocol layer such as the physical hardware layer, communication layer (e.g., radio), data layer, software layer, etc. Encryption may include human interaction and confirmation with built-in and selectable security options, such as, but not limited to, encoding, encrypting, hashing, layering, obscuring, password protecting, obfuscation of data transmission, frequency hopping, and various combinations thereof. As a nonlimiting example, the prevention of spoofing and/or eavesdropping may be accomplished by adding two-prong security communication and confirmation using two or more data communication methods (e.g., light and radio) and protocols (e.g., pattern and freq. hopping). Thus, at least one area of security, as provided above, may be applied to at least provide for communication being encrypted while in the cloud; communication with user(s) 102 that may occur via the Internet 106, a Wi-Fi connection, Bluetooth® (a wireless technology standard standardized as IEEE 802.15.1), satellite, or another communication link; communications between computing device(s) 104 and other computing device(s) 104; communications between Internet of Things devices and computing device(s) 104; and the like.

The Internet of Things, also known as IoT, is a network of physical objects or “things” embedded with electronics, software, sensors, and connectivity to enable objects to exchange data with the manufacturer, operator, and/or other connected devices based on the infrastructure of International Telecommunication Union's Global Standards Initiative. The Internet of Things allows objects to be sensed and controlled remotely across existing network infrastructure, creating opportunities for more direct integration between the physical world and computer-based systems, and resulting in improved efficiency, accuracy, and economic benefit. Each thing is uniquely identifiable through its embedded computing system but is able to interoperate within the existing Internet infrastructure. Communications may comprise use of transport layer security (“TLS”), fast simplex link (“FSL”), data distribution service (“DDS”), hardware boot security, device firewall, application security to harden from malicious attacks, self-healing/patching/firmware upgradability, and the like. Security may be further included by using at least one of: obfuscation of data transmission, hashing, cryptography, public key infrastructure (PKI), secured boot access, and the like.

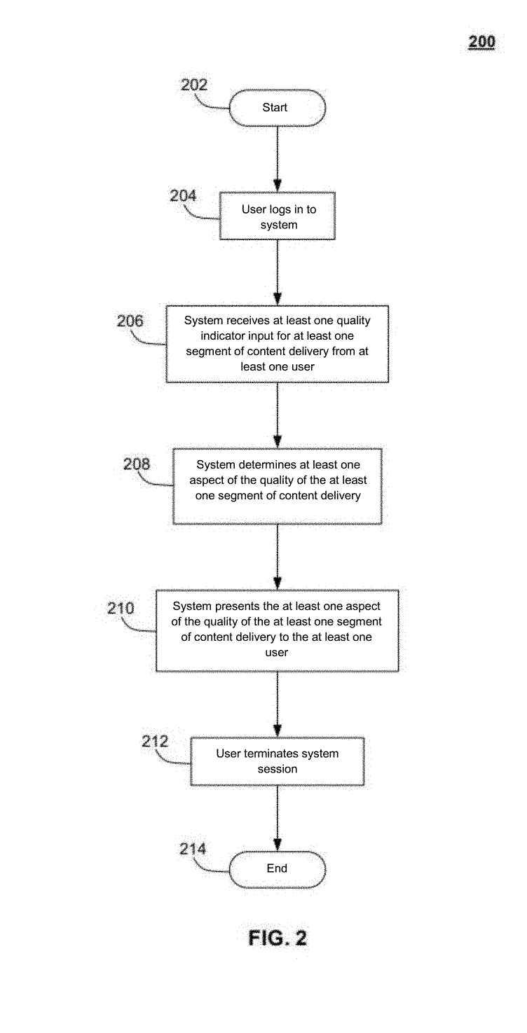

Referring now to FIG. 2, a flowchart illustrating an exemplary process 200 for evaluating the quality of at least one segment of content delivery, according to an aspect of the present disclosure, is shown.

Process 200, which may at least partially execute within system 100 (not shown in FIG. 2), begins at step 202 with control passing immediately to step 204.

At step 204, a user 102 (not shown in FIG. 2) logs in to system 100 via a computing device 104 (not shown in FIG. 2). In some aspects, user 102 or computing device 104 may provide login credentials, thereby allowing access to an account or profile associated with user 102. By way of example and not limitation, the login credentials may take place via a software application, a website, a web application, or the like accessed by computing device 104. By way of further example and not limitation, login credentials may comprise a username, password, passcode, key code, pin number, visual identification, fingerprint scan, retinal scan, voice authentication, facial recognition, and/or any similar identifying and/or security elements as may be apparent to those skilled in the relevant art(s) after reading the description herein as being able to securely determine the identity of user 102. In some aspects, user 102 may login using a login service such as a social media login service, an identity/credential provider service, a single sign on service, and the like. In various aspects, users 102 may create user 102 accounts/profiles via such login services. Any user 102 accounts/profiles may, in some aspects, be stored within and retrieved from, by way of example and not limitation, user database 128 (not shown in FIG. 2).

At step 206, system 100 receives at least one quality indicator input for at least one segment of content delivery from at least one user 102. In some nonlimiting embodiments, by way of example and not limitation, user(s) 102 may submit one or more quality indicators to system 100 by using one or more input devices (e.g., a mouse, keyboard, touchscreen, joystick, microphone, camera, scanner, chip reader, card reader, magnetic stripe reader, near field communication technology, and the like) that may be associated with a computing device 104. In some aspects, this may allow user(s) 102 to manipulate a graphical user interface presented via a monitor, display screen, or similar device(s) that may be associated with computing device 104 in order to input various types of quality indicator data (such as, by way of example and not limitation, by selecting one or more check boxes or radio buttons, selecting a choice from at least one drop-down list, entering one or more characters into at least one textbox, etc.).

The at least one quality indicator may comprise any objective data that may at least partially represent the quality of at least one portion (i.e., segment) of content delivery, such as, for example and not limitation, ten minutes of a presenter's lecture (either in person, virtual, or prerecorded), a classroom activity, a case study, a quiz, a game, a simulation, a role play activity, a brainstorming session, a learner presentation, a laboratory experiment, a chapter or lesson from an online course, a video, an animation, a demonstration, a whiteboard/chalkboard/flip chart based explanation, five minutes of a talk show, a speech from a politician, an email from a supervisor to an employee, a recording of a healthcare provider's consultation with a patient, five minutes of an actor's performance on television, ten minutes of a comedy routine, and/or a radio show discussion, as well as any similar types of content delivery segment(s) as may be apparent to those skilled in the relevant art(s) after reading the description herein (as well as any combination thereof). By way of example and not limitation, a quality indicator may comprise an indication of whether or when an active or passive learning instance occurs (e.g., a hands-on group activity may comprise active learning while a lecture may comprise passive learning); what type of active or passive learning instance occurs (e.g., a discussion, laboratory experiment, lecture, group activity, question and answer session, etc.); whether the content delivery segment allows learner(s) to branch into different activities or topics (and if so, how many times this occurs); how often key words, phrases, and/or topics are referenced, whether an informal question is asked by the content deliverer; whether a reference to a real-life application is made by the content deliverer; whether the content deliverer or training material indicates how learner(s) may benefit from a given piece of information; whether previously presented information is reviewed; whether a variety of active learning types are used; whether a variety of passive learning types are used; whether one or more training props, visual aids and/or models are used (and whether their design and subject matter is appropriate); whether an effective classroom environment is maintained (e.g., whether the environment is relaxed and comfortable); whether the content deliverer practices good presentation skills (e.g. maintains natural eye contact, avoids “non-words” (e.g., “umm,” “er,” “uhh,” etc.)); whether the content deliverer uses appropriate vocal inflections (e.g., whether the deliverer shows enthusiasm); whether the content deliverer uses good/appropriate diction; whether the content deliverer references course framework; how long it takes learner(s) to perform an action or answer a question once asked to do so (such as, for example and not limitation, how long it takes learner(s) to get out calculators when prompted) (e.g., to measure learner motivation); as well as any similar actions, instances, or occurrences as may be apparent to those skilled in the relevant art(s) after reading the description herein as being indicative of the quality of one or more segments of content delivery, including any combination thereof.

At step 208, system 100 determines at least one aspect of the quality of the at least one segment of content delivery. By way of example and not limitation, the at least one aspect of quality may comprise whether a desirable balance is achieved between active and passive learning instances, whether a differentiation of instruction is used, whether spaced learning is used, whether learners seem properly motivated, whether a variety of active learning instances are used, whether a variety of passive learning instances are used, whether a combination of presentation/instruction methods are used that may optimize learner learning potential (e.g., whether more than two or three presentation/instruction methods were used to avoid issues of boredom that may lead to disinterest and inattentiveness), whether one or more content delivery requirements are met (e.g., whether prescribed speaking and/or writing methods are followed, whether proper physical actions are taken, etc.), and/or whether one or more psychological appeals are made and at what times, as well as any similar quality aspects as may be apparent to those skilled in the relevant art(s) after reading the description herein. This determination may be made, at least partially, by using one or more computing devices 104 (not shown in FIG. 2) to analytically compare received quality indicator(s) with one or more predetermined standards or other data that may be stored, by way of example and not limitation, within content database 124 (not shown in FIG. 2). By way of further example and not limitation, the one or more standards may comprise a desirable balance between active and passive learning instances, wherein any passive learning instance(s) may be limited to lasting between one and fifteen minutes for in-person presenter led educational content segments, between one and five minutes for virtual presenter led educational content segments, and between one and three minutes for software-based, online-based, or eLearning style educational content segments without engaging in at least one active learning instance. Maintaining an appropriate balance between active and passive learning instances may play an important role in helping learner(s) absorb and retain presented material. As will be appreciated by those skilled in the relevant art(s) after reading the description herein, other durations of passive and/or active learning instance(s) may be used without departing from the scope of the present disclosure.

At step 210, system 100 presents the at least one aspect of the quality of the at least one segment of content delivery to user(s) 102. By way of example and not limitation, this presentation may be made via one or more monitors, display screens, or similar display device(s) that may be associated with one or more computing devices 104 and/or one or more devices that may be communicatively coupled to computing device(s) 104, either wirelessly or via wired connectivity, and configured to present at least one visual, audio, and/or tactile output to at least one deliverer of at least one segment of content delivery (such as, by way of example and not limitation, a speaker that produces a beeping or buzzing sound if a deliverer engages in a passive learning instance for too long and/or a vibration device that produces at least one type of vibration to indicate to a deliverer when it is time to switch from a passive learning instance to an active learning instance). In some nonlimiting exemplary embodiments, any visual information may be presented in the form of one or more line graphs, bar graphs, and/or pie charts (e.g., a line graph may depict how long various active and/or passive instances lasted during a particular educational content delivery segment, a pie chart may depict the percentages of time various activities lasted during an educational content delivery segment, a bar graph may indicate how many times a politician said a “non-word” (e.g., “umm,” “er,” “uhh,” etc.) during a speech, etc. In some additional nonlimiting exemplary embodiments, information may be presented in the form of one or more preformed statements that system 100 may select based on the determination(s) made at step 208 (such as, for example and not limitation, “The presenter never engaged in passive learning for more than seventeen minutes without engaging in at least one active learning instance”). By knowing such aspect(s) of quality for various segment(s) of content delivery, user(s) 102 may be able to determine if the segment(s) are worth the cost, how the segment(s) compare to similar segment(s) offered by competitors, and/or whether a company delivering the segment(s) to employees, patients, or clients might be eligible for various benefits (such as, for example and not limitation, insurance discounts if it can be shown that the segment(s) minimize workplace accidents or malpractice claims). In some aspects, user(s) 102 may be able to select which aspect(s) of quality are presented as well as what format (e.g., pictorial or text) the aspect(s) are presented in.

At step 212, user 102 terminates the open session within system 100. All communication between computing device(s) 104 and system 100 may be closed. In some aspects, user 102 may log out of system 100, though this may not be necessary.

In various aspects, steps 204 and 212 of process 200 may be omitted, as user 102 may not be required to log in or log out of system 100, as will be appreciated by those skilled in the relevant art(s) after reading the description herein.

At step 214 process 200 is terminated and process 200 ends.

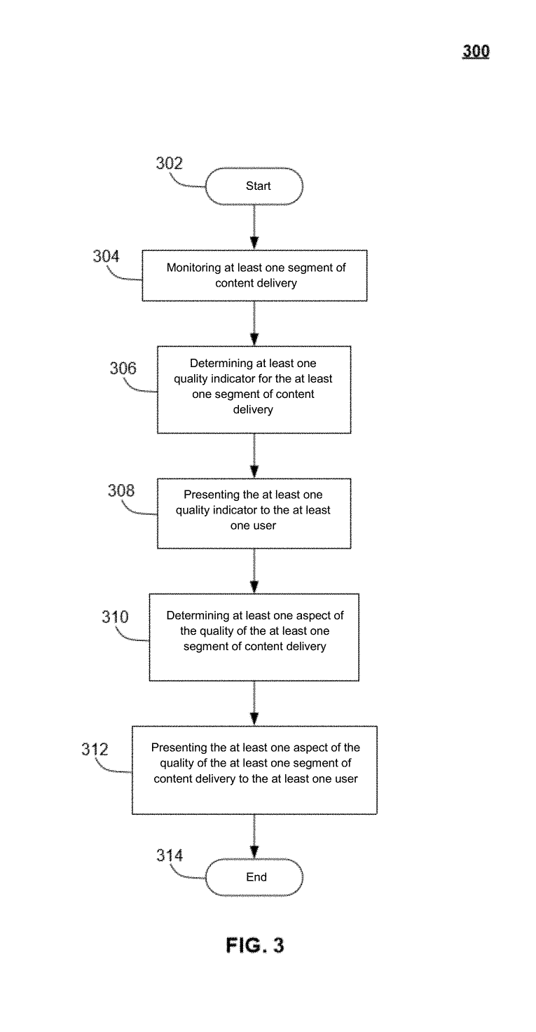

Referring now to FIG. 3, a flowchart illustrating an exemplary process 300 for determining at least one quality indicator for and evaluating the quality of at least one segment of content delivery, according to an aspect of the present disclosure, is shown.

Process 300, which may at least partially execute within system 100 (not shown in FIG. 3), begins at step 302 with control passing immediately to step 304.

At step 304, system 100 monitors at least one segment of content delivery. This may be accomplished in a variety of ways. For example, in some nonlimiting exemplary embodiments, one or more cameras, microphones, heart rate monitors, sphygmomanometers pulse oximeters, and/or similar sensory devices 134 (not shown in FIG. 3) communicatively coupled with one or more computing devices 104 (not shown in FIG. 3) may be configured so as to perceive, capture, and/or record one or more portions or aspects of an in-person content delivery segment, such as, by way of example and not limitation, words spoken by a content deliverer and/or one or more content recipients 136 (not shown in FIG. 3), actions taken by a content deliverer, as well as the heart rate, blood pressure, pulse rate, and/or similar biological data of one or more content recipients 136 which may be indicative of the involvement, attentiveness, and/or engagement of content recipients 136. In some additional aspects, by way of further example and not limitation, one or more computing devices 104 may record at least one portion of a prerecorded and/or software-based or online-based (e.g., a broadcast via YouTube® (available from YouTube, LLC of San Bruno, Calif.), a “podcast” or netcast, an “eLearning” session, etc.) content delivery segment as it is presented by way of such computing device(s) 104. Other content delivery segment monitoring methods, means, and/or techniques may be used as may be apparent to those skilled in the relevant art(s) after reading the description herein.

At step 306, system 100 determines at least one quality indicator for the at least one segment of educational content. In some nonlimiting exemplary embodiments, computing device(s) 104 that may monitor the at least one segment of content delivery at step 304 may further include computational instructions, or code, in the form of software or one or more software applications that may be executed by one or more computer processers in order to identify one or more quality indicators that may occur during the monitored segment of content delivery (such as, for example, being configured to detect changes in the deliverer's vocal tone or volume; to identify various key words or phrases that signal, for example, if a review session is taking place or an informal question is being asked; to determine a time duration of various active learning instances; to determine learner response times to measure learner motivation levels; and to make similar determinations using various metrics and/or standards.

At step 308, system 100 presents one or more users 102 (not shown in FIG. 3) with the at least one quality indicator determined at step 306. Such presentation may comprise a variety of forms, including a notification of each quality indicator as it is found (such as, for example and not limitation, via a sound and/or text message), one or more lists of multiple quality indicators found, charts or graphs depicting the frequency of various quality indicators (e.g., a pie chart may depict a percentage of quality indicators that comprised an informal question being asked or a mention of a course objective while a bar graph may depict a scale that may display how a content deliverer's vocal volume or tone compared to desirable range(s)). In some aspects, by way of example and not limitation, the presentation may occur via one or more display screens, monitors, or similar display device(s) that may be associated with one or more computing devices 104. In some additional aspects, user(s) 102 may be able to select which quality indicator(s) are presented as well as what format (e.g., pictorial or text) the quality indicator(s) are presented in.

At step 310, system 100 determines at least one aspect of the quality of the at least one segment of content delivery. By way of example and not limitation, the at least one quality aspect may comprise whether a desirable balance is achieved between active and passive learning instances, whether differentiation of instruction is achieved, whether spaced learning is achieved, whether learners seem properly motivated, whether a variety of active learning instances are used, whether a variety of passive learning instances are used, whether a combination of presentation/instruction methods are used that may optimize learner learning potential, whether one or more content delivery requirements are met (e.g., whether prescribed speaking and/or writing methods are followed, whether proper physical actions are taken, etc.), and/or whether one or more psychological appeals are made and at what times, as well as any similar quality aspects as may be apparent to those skilled in the relevant art(s) after reading the description herein. This determination may be made, at least partially, by analytically comparing quality indicator(s) determined at step 306 with one or more standards or other data that may be stored, by way of example and not limitation, within content database 124 (not shown in FIG. 3). By way of further example and not limitation, the one or more standards may comprise a desirable balance between active and passive learning instances, wherein passive learning instances preferably last between one and fifteen minutes for in-person presenter led educational content delivery segments, between one and five minutes for virtual presenter led educational content delivery segments, and between one and three minutes for software-based, online-based, or eLearning style educational content delivery segments without engaging in at least one active learning instance. Maintaining an appropriate balance between active and passive learning instances may play an important role in helping learner(s) absorb and retain presented material.

At step 312, system 100 presents the at least one aspect of the quality of the at least one segment of content delivery to user(s) 102. By way of example and not limitation, this presentation may be made via one or more monitors, display screens, or similar display device(s) that may be associated with one or more computing devices 104 and/or one or more devices that may be communicatively coupled to computing device(s) 104, either wirelessly or via wired connectivity, and configured to present at least one visual, audio, and/or tactile output to at least one deliverer of at least one segment of content delivery (such as, by way of example and not limitation, a speaker that produces a beeping or buzzing sound if a deliverer engages in a passive learning instance for too long and/or a vibration device that produces at least one type of vibration to indicate to a deliverer when it is time to switch from a passive learning instance to an active learning instance). In some nonlimiting exemplary embodiments, any visual information may be presented in the form of one or more line graphs, bar graphs, and/or pie charts (e.g., a line graph may depict how long various active and/or passive instances lasted during an educational content delivery segment, a pie chart may depict the percentages of time various activities lasted during an educational content delivery segment, a bar graph may indicate how many times a politician said a “non-word” (e.g., “umm,” “er,” “uhh,” etc.) during a speech, etc.). In some additional nonlimiting exemplary embodiments, information may be presented in the form of one or more preformed statements that system 100 may select based on the determination(s) made at step 310 (such as, for example and not limitation, “The presenter never engaged in passive learning for more than seventeen minutes without engaging in at least one active learning instance”). By knowing such aspect(s) of quality for various segment(s) of content delivery, user(s) 102 may be able to determine if the segment(s) are worth the cost, how the segment(s) compare to similar segment(s) offered by competitors, and/or whether a company delivering the segment(s) to employees might be eligible for various benefits (such as, for example and not limitation, insurance discounts if it can be shown that the segment(s) minimize workplace accidents or malpractice claims). In some aspects, user(s) 102 may be able to select which aspect(s) of quality are presented as well as what format (e.g., pictorial or text) the aspect(s) are presented in.

At step 314 process 300 is terminated and process 300 ends.

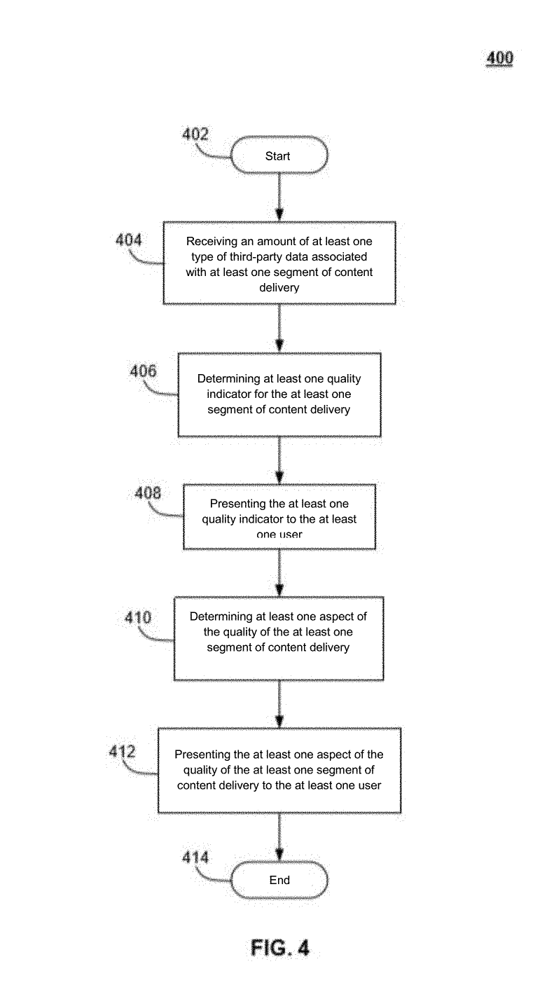

Referring now to FIG. 4, a flowchart illustrating an exemplary process 400 for determining at least one quality indicator for and evaluating the quality of at least one segment of content delivery based at least partially on at least one type of third-party data, according to an aspect of the present disclosure, is shown.

Process 400, which may at least partially execute within system 100 (not shown in FIG. 4), begins at step 402 with control passing immediately to step 404.

At step 404, system 100 receives (or retrieves) an amount of at least one type of third-party data associated with at least one portion of at least one segment of content delivery. By way of example and not limitation, the data may be associated with one or more segments of content delivery generated by one or more individuals or entities (such as, for example and not limitation, via one or more types of eLearning authoring software (such as the Articulate 360® software available from Articulate Global, Inc. of New York, N.Y.)), or the data may be associated with material or information from a learning management system (LMS), a learning record store (LRS), a content management system (CMS), a component content management system (CCMS), a training analytics or evaluation database and/or any similar source(s) as may be apparent to those skilled in the relevant art(s) after reading the description herein. In some nonlimiting exemplary embodiments, the amount of at least one type of third-party data may comprise standards, specifications, communication protocols, data storage formats, and/or code that may be used in order to interpret and/or extract (or “pull”) information about one or more segments of one or more software-based, online-based, or “eLearning” style (or other virtual format) educational instruction courses that may be developed or “written” using such and/or conforming to such standards, specifications, communication protocols, data storage formats, and/or code. By way of further example and not limitation, the at least one type of third-party data may comprise SCORM®, AICC, cmi5, Caliper Analytics®, or xAPI (also known as Experience API and/or “Tin Can”) data that may be obtained from a particular software-based, online-based, or eLearning style (or other virtual format) course by way of one or more computing devices 104 (not shown in FIG. 4). Computing device(s) 104 may be equipped with computational instructions, or code, in the form of software or one or more software applications that, when executed by one or more computer processors, enables the processor(s) to identify and retrieve desired and/or relevant quality indicator(s) from within the SCORM®, AICC, cmi5, Caliper Analytics®, xAPI, and/or similar third-party data.

At step 406, system 100 determines at least one quality indicator for the at least one segment of content delivery associated with the data received at step 404. In some aspects, this determination may be made by converting the data into a different form, such as, by way of example and not limitation, in the form of extensible markup language (XML), which may be parsed in order to be utilized by one or more components of system 100, such as one or more computing devices 104. Such computing device(s) 104 may include computational instructions, or code, in the form of software or one or more software applications that may be executed by one or more computer processers in order to analyze the received third-party data and identify one or more quality indicators that may be embedded therein.

At step 408, system 100 presents one or more users 102 (not shown in FIG. 4) with the at least one quality indicator determined at step 406. Such presentation may comprise a variety of forms, including a notification of each quality indicator as it is found (such as, for example and not limitation, via a sound and/or text message), one or more lists of multiple quality indicators found, charts or graphs depicting the frequency of various quality indicators (e.g., a pie chart may depict a percentage of quality indicators that comprised an informal question being asked or a mention of a course objective while a bar graph may depict a scale that may display how a content deliverer's vocal volume or tone compared to desirable range(s)). In some aspects, by way of example and not limitation, the presentation may occur via one or more display screens, monitors, or similar display device(s) that may be associated with one or more computing devices 104. In some additional aspects, user(s) 102 may be able to select which quality indicator(s) are presented as well as what format (e.g., pictorial or text) the quality indicator(s) are presented in.

At step 410, system 100 determines at least one aspect of the quality of the at least one segment of content delivery. By way of example and not limitation, the at least one quality aspect may comprise whether a desirable balance is achieved between active and passive learning instances, whether differentiation of instruction is achieved, whether spaced learning is achieved, whether learners seem properly motivated, whether a variety of active learning instances are used, whether a variety of passive learning instances are used, whether a combination of presentation/instruction methods are used that may optimize learner learning potential, whether one or more content delivery requirements are met (e.g., whether prescribed speaking and/or writing methods are followed, whether proper physical actions are taken, etc.), and/or whether one or more psychological appeals are made and at what times, as well as any similar quality aspects as may be apparent to those skilled in the relevant art(s) after reading the description herein. This determination may be made, at least partially, by analytically comparing quality indicator(s) determined at step 406 with one or more standards or other data that may be stored, by way of example and not limitation, within content database 124 (not shown in FIG. 4). By way of further example and not limitation, the one or more standards may comprise a desirable balance between active and passive learning instances, wherein passive learning instances preferably last between one and fifteen minutes for in-person presenter led educational content delivery segments, between one and five minutes for virtual presenter led educational content delivery segments, and between one and three minutes for software-based, online-based, or eLearning style educational content delivery segments without engaging in at least one active learning instance. Maintaining an appropriate balance between active and passive learning instances may play an important role in helping learner(s) absorb and retain presented material.

At step 412, system 100 presents the at least one aspect of the quality of the at least one segment of content delivery to user(s) 102. By way of example and not limitation, this presentation may be made via one or more monitors, display screens, or similar display device(s) that may be associated with at least one computing device 104 and/or one or more devices that may be communicatively coupled to computing device(s) 104, either wirelessly or via wired connectivity, and configured to present at least one visual, audio, and/or tactile output to at least one deliverer of at least one segment of content delivery (such as, by way of example and not limitation, a speaker that produces a beeping or buzzing sound if a deliverer engages in a passive learning instance for too long and/or a vibration device that produces at least one type of vibration to indicate to a deliverer when it is time to switch from a passive learning instance to an active learning instance). In some nonlimiting exemplary embodiments, any visual information may be presented in the form of one or more line graphs, bar graphs, and/or pie charts (e.g., a line graph may depict how long various active and/or passive instances last during an educational content delivery segment, a pie chart may depict the percentages of time various activities last during a given educational content delivery segment, a bar graph may indicate how many times a politician said a “non-word” (e.g., “umm,” “er,” “uhh,” etc.) during a speech, etc.). In some additional nonlimiting exemplary embodiments, information may be presented in the form of one or more preformed statements that system 100 may select based on the determination(s) made at step 410 (such as, for example and not limitation, “Passive learning does not occur for more than seventeen minutes without engaging in at least one active learning instance”). By knowing such aspect(s) of quality for various segment(s) of content delivery, user(s) 102 may be able to determine if the segment(s) are worth the cost, how the segment(s) compare to similar segment(s) offered by competitors, if the segment(s) are designed or structured for maximum effectiveness, and/or whether a company delivering the segment(s) to employees might be eligible for various benefits (such as, for example and not limitation, insurance discounts if it can be shown that the segment(s) minimize workplace accidents or malpractice claims). In some aspects, user(s) 102 may be able to select which aspect(s) of quality are presented as well as what format (e.g., pictorial or text) the aspect(s) are presented in.

At step 414 process 400 is terminated and process 400 ends.

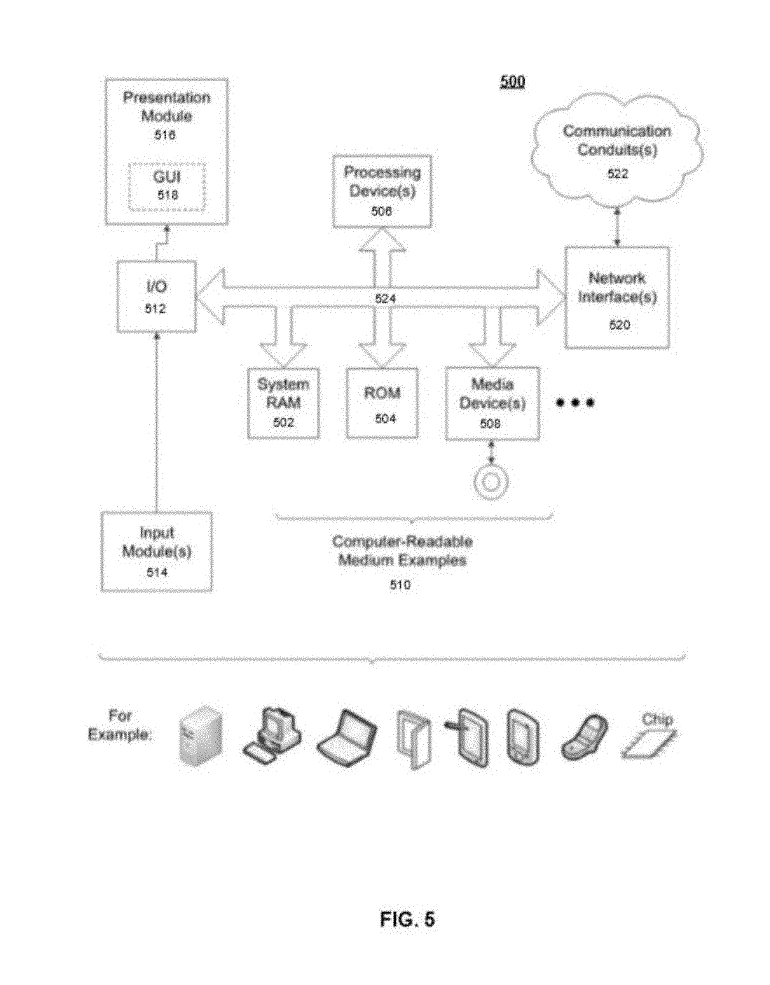

Referring now to FIG. 5, a block diagram of an exemplary computing system 500 useful for implementing one or more aspects of the present disclosure is shown.

FIG. 5 sets forth illustrative computing functionality 500 that may be used to implement web server(s) 120, application server(s) 122, one or more gateways 108-118, content database 124, third-party data database 126, user database 128, computing devices 104 utilized by user(s) 102 to access Internet 106, or any other component of system 100. In all cases, computing functionality 500 represents one or more physical and tangible processing mechanisms.

Computing functionality 500 may comprise volatile and non-volatile memory, such as RAM 502 and ROM 504, as well as one or more processing devices 506 (e.g., one or more central processing units (CPUs), one or more graphical processing units (GPUs), and the like). Computing functionality 500 also optionally comprises various media devices 508, such as a hard disk module, an optical disk module, and so forth. Computing functionality 500 may perform various operations identified when the processing device(s) 506 execute(s) instructions that are maintained by memory (e.g., RAM 502, ROM 504, and the like).

More generally, instructions and other information may be stored on any computer readable medium 510, including, but not limited to, static memory storage devices, magnetic storage devices, and optical storage devices. The term “computer readable medium” also encompasses plural storage devices. In all cases, computer readable medium 510 represents some form of physical and tangible entity. By way of example and not limitation, computer readable medium 510 may comprise “computer storage media” and “communications media.”

“Computer storage media” comprises volatile and non-volatile, removable and non-removable media implemented in any method or technology for storage of information, such as computer readable instructions, data structures, program modules, or other data. Computer storage media may be, for example, and not limitation, RAM 502, ROM 504, EEPROM, Flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as wired network or direct-wired connection, and wireless media such as acoustic, RF, infrared, and other wireless media. Combinations of any of the above are also included within the scope of computer readable medium.

Computing functionality 500 may also comprise an input/output module 512 for receiving various inputs (via input modules 514), and for providing various outputs (via one or more output modules). One particular output module mechanism may be a presentation module 516 and an associated GUI 518. Computing functionality 500 may also include one or more network interfaces 520 for exchanging data with other devices via one or more communication conduits 522. In some aspects, one or more communication buses 524 communicatively couple the above-described components together.

Communication conduit(s) 522 may be implemented in any manner (e.g., by a local area network, a wide area network (e.g., the Internet), and the like, or any combination thereof). Communication conduit(s) 522 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

The terms “module” and “component” as used herein generally represent software, firmware, hardware, or any combination thereof. In the case of a software implementation, the module or component represents program code that performs specified tasks when executed on one or more processors. The program code may be stored in one or more computer readable memory devices, as described with reference to FIG. 5. The features of the present disclosure described herein are platform-independent, meaning the techniques can be implemented on a variety of commercial computing platforms having a variety of processors (e.g., desktop, laptop, notebook, tablet computer, personal digital assistant (PDA), mobile telephone, smart telephone, gaming console, and the like).

In view of the above, a non-transitory processor readable storage medium is provided. The storage medium comprises an executable computer program product which further comprises a computer software code that, when executed on a processor, causes the processor to perform certain steps or processes. Such steps may include, but are not limited to, causing the processor to determine at least one quality indicator for at least one segment of content delivery, present the at least one quality indicator to at least one user, determine at least one aspect of the quality of the at least one segment of content delivery, and present the at least one aspect of the quality of the at least one segment of content delivery to the at least one user. Such steps may also include, without limitation, causing the processor to monitor at least one segment of content delivery, receive an amount of at least one type of third-party data associated with at least one segment of content delivery, and/or receive at least one quality indicator input for at least one segment of content delivery from the at least one user.

It is noted that the order of the steps of processes 200-400, including the starting points thereof, may be altered without departing from the scope of the present disclosure, as will be appreciated by those skilled in the relevant art(s) after reading the description herein.

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects.

In addition, it should be understood that the figures in the attachments, which highlight the structure, methodology, functionality, and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein). As will be appreciated by those skilled in the relevant art(s) after reading the description herein, certain features from different aspects of the systems, methods and computer program products of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A method for facilitating the evaluation of at least one segment of content delivery, the method comprising:
receiving, via at least one input device associated with at least one computing device, at least one quality indicator for the at least one segment of content delivery from at least one user;
determining, via the at least one computing device, at least aspect of the quality of the at least one segment of content delivery by comparing the at least one quality indicator with at least one predetermined standard; and
presenting, via at least one display device associated with the at least one computing device, the at least one aspect of the quality of the at least one segment of content delivery to the at least one user.

2. The method of claim 1, wherein the at least one aspect of the quality of the at least one segment of content delivery is presented in at least one visual form.

3. The method of claim 2, wherein the at least one visual form comprises at least one of: text, a pie chart, a line graph, and a bar graph.

4. A method for facilitating an at least partially autonomous evaluation of at least one segment of content delivery, the method comprising:
monitoring, via one or more sensory devices associated with one or more computing devices, the at least one segment of content delivery;
determining, via the at least one computing device, at least one quality indicator for the at least one segment of content delivery by analyzing the at least one segment of content delivery using one or more metrics or standards; and
presenting, via at least one display device associated with the at least one computing device, the at least one quality indicator to at least one user.

5. The method of claim 2, wherein the method further comprises the step of:
determining, via the at least one computing device, at least aspect of the quality of the at least one segment of content delivery by comparing the at least one quality indicator with at least one predetermined standard.

6. The method of claim 5, wherein the method further comprises the step of:
presenting, via at least one display device associated with the at least one computing device, the at least one aspect of the quality of the at least one segment of content delivery to the at least one user.

7. The method of claim 2, wherein the at least one segment of content delivery comprises educational content.

8. The method of claim 2, wherein the at least one sensory device comprises at least one of: a camera, a microphone, and a wearable technology device worn by at least one content recipient.

9. The method of claim 8, wherein the wearable technology device comprises at least one of: a heart rate monitor, a sphygmomanometer, and a pulse oximeter.

10. The method of claim 6, wherein the at least one aspect of the quality of the at least one segment of content delivery is presented in at least one visual form.

11. The method of claim 10, wherein the at least one visual form comprises at least one of: text, a pie chart, a line graph, and a bar graph.

12. The method of claim 6, wherein the at least one aspect of the quality of the at least one segment of content delivery is presented in at least one audio or tactile form.

13. The method of claim 12, wherein the at least one audio or tactile form comprises at least one of: an audio output from a speaker and a vibration produced by a vibrating device.

14. A method for facilitating an at least partially autonomous evaluation of at least one segment of content delivery using an amount of at least one type of third-party data, the method comprising:
receiving, via at least one computing device, the amount of at least one type of third-party data associated with the at least one segment of content delivery;
determining, via the at least one computing device, at least one quality indicator for the at least one segment of content delivery by converting the third-party data to extensible markup language and parsing the extensible markup language for one or more quality indicators that may be embedded therein; and
presenting, via at least one display device associated with the at least one computing device, the at least one quality indicator to at least one user.

15. The method of claim 14, wherein the method further comprises the step of:
determining, via the at least one computing device, at least aspect of the quality of the at least one segment of content delivery by comparing the at least one quality indicator with at least one predetermined standard.

16. The method of claim 15, wherein the method further comprises the step of:
presenting, via at least one display device associated with the at least one computing device, the at least one aspect of the quality of the at least one segment of content delivery to the at least one user.

17. The method of claim 14, wherein the at least one segment of content delivery comprises educational content.

18. The method of claim 17, wherein the at least one type of third-party data comprises one or more standards for online-based educational content.

19. The method of claim 16, wherein the at least one aspect of the quality of the at least one segment of content delivery is presented in at least one visual form.

20. The method of claim 19, wherein the at least one visual form comprises at least one of: text, a pie chart, a line graph, and a bar graph.
